(19) United States
(12) Patent Application Publication
(10) Pub. No.: US 2012/0278721 A1
(43) Pub. Date: Nov. 1, 2012

(54) Museum Tour System and Method

(76) Inventor: Christopher Thomas Beidel, Glendale, WI (US)

(21) Appl. No.: 13/398,705

(22) Filed: Feb. 16, 2012

Related U.S. Application Data
(60) Provisional application No. 61/444,073, filed on Feb. 17, 2011.

(51) Int. Cl. H04B 7/26; G06F 3/048

(52) U.S. Cl. 715/733; 340/10.6

(57) ABSTRACT

Embodiments of the invention provide a museum tour system to be used by a museum administrator and a museum guest. The system can include a museum object database in a server to store a plurality of museum object records. The system can also include a museum portal that can provide a user interface in which the museum administrator adds museum object records, creates tours, edits tours, or adds products. The system can include a mobile device application to provide a tour segment to a mobile computing device of the museum guest when the museum guest approaches the museum object. The mobile device application can recognize a proximity of the museum guest to the museum object in order to choose the appropriate tour segment.

### RELATED APPLICATIONS

This application is a continuation of co-pending U.S. Provisional Application Ser. No. 61/444,073, filed on Feb. 17, 2011, the entire contents of which is incorporated herein by reference.

### BACKGROUND

Museum tours have conventionally been offered with portable audio devices and headphones. The portable audio devices are maintained by the museum and checked out from the museum by each museum guest. As the museum guest walks through the museum, he or she enters numbers for each art object or exhibit into the portable audio device. Once the correct number is entered, the portable audio device provides a pre-recorded audio tour corresponding to the art object or exhibit.

### SUMMARY

Some embodiments of the invention provide a museum tour system implemented with a host computer, a server, and a mobile computing device connected by a network. The museum tour system can be used by a museum administrator and a museum guest who is viewing museum objects. The system can include a museum object database in the server. The museum object database can store a plurality of museum object records. The system can also include a museum portal accessible on the host computer. The museum portal can provide a user interface in which the museum administrator adds museum object records, creates tours, edits tours, or adds products. The system can further include a mobile device application accessible with the mobile computing device. The mobile device application can provide a tour segment to the mobile computing device of the museum guest when the museum guest approaches the museum object. In some embodiments, the mobile device application can automatically recognize a proximity of the museum guest to the museum object in order to choose the appropriate tour segment.

### DESCRIPTION OF THE DRAWINGS

FIG. 1 is a block diagram of a museum tour system according to one embodiment of the invention.

FIG. 2 is a representation of a graphical screen of a museum portal including a plurality of museum object records according to one embodiment of the invention.

FIG. 3 is a representation of a graphical screen of the museum portal including a single museum object record according to one embodiment of the invention.

FIG. 4 is a representation of a graphical screen of the museum portal including a museum product record according to one embodiment of the invention.

FIG. 5 is a representation of a graphical screen of the museum portal including a museum portal home according to one embodiment of the invention.

FIG. 6 is a representation of a graphical screen of the museum portal including a museum object search page according to one embodiment of the invention.

FIG. 7 is a representation of a graphical screen of the museum portal including a product search page according to one embodiment of the invention.

FIG. 8 is a representation of a graphical screen of the museum portal including an edit object page according to one embodiment of the invention.

FIG. 9 is a representation of a graphical screen of the museum portal including an object search results page according to one embodiment of the invention.

FIG. 10 is a representation of a graphical screen of the museum portal including an edit product page according to one embodiment of the invention.

FIG. 11 is a representation of a graphical screen of the museum portal including an add tour page according to one embodiment of the invention.

FIG. 12 is a representation of a graphical screen of the museum portal including a tour search results page according to one embodiment of the invention.

FIG. 13 is a representation of a graphical screen of the museum portal including an edit tour page according to one embodiment of the invention.

FIG. 14 is a representation of a graphical screen of the museum portal including an existing activity search results page according to one embodiment of the invention.

FIG. 15 is a representation of a graphical screen of the museum portal including an edit existing activity page according to one embodiment of the invention.

FIG. 16 is a representation of a graphical screen of the museum portal including another existing activity search results page according to one embodiment of the invention.

FIG. 17 is a representation of a graphical screen of the museum portal including another edit existing activity page according to one embodiment of the invention.

FIG. 18 is a representation of a graphical screen of the museum portal including another existing activity search results page according to one embodiment of the invention.

FIG. 19 is a representation of a graphical screen of the museum portal including another edit existing activity page according to one embodiment of the invention.

FIG. 20 is a representation of a graphical screen of a mobile device application including a select an activity screen according to one embodiment of the invention.

FIG. 21 is a representation of a graphical screen of the mobile device application including a donation screen according to one embodiment of the invention.

FIG. 22 is a representation of a graphical screen of the mobile device application including a museum general information screen according to one embodiment of the invention.

FIG. 23 is a representation of a graphical screen of the mobile device application including a museum map screen according to one embodiment of the invention.

FIG. 24 is a representation of a graphical screen of the mobile device application including a museum object tour page according to one embodiment of the invention.

FIG. 25 is a representation of a graphical screen of the mobile device application including a museum location search screen according to one embodiment of the invention.

FIG. 26 is a representation of a graphical screen of the mobile device application including an artist search screen according to one embodiment of the invention.

FIG. 27 is a representation of a graphical screen of the mobile device application including another museum general information screen according to one embodiment of the invention.

FIG. 28 is a representation of a graphical screen of the mobile device application including a museum tour selection screen according to one embodiment of the invention.

FIG. 29 is a representation of a graphical screen of the mobile device application including an activities and trivia selection screen according to one embodiment of the invention.

FIG. 30 is a representation of a graphical screen of the mobile device application including a museum collection search screen according to one embodiment of the invention.

FIG. 31 is a representation of a graphical screen of the mobile device application including another museum object tour screen according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

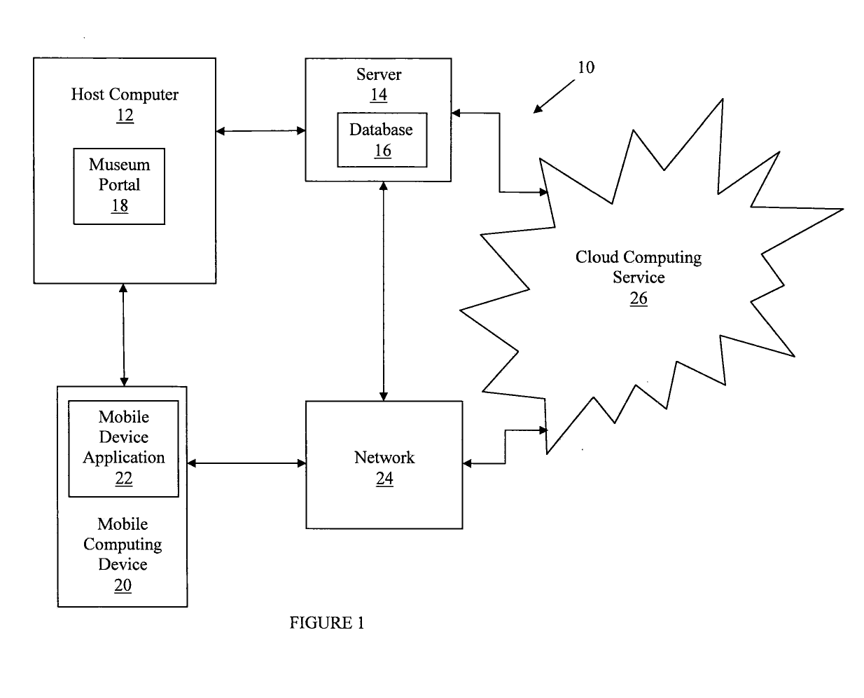

FIG. 1 illustrates a museum tour system 10 according to one embodiment of the invention. The museum tour system 10 can act as a technology-based guide for museum guests without the need for a live docent. The system 10 can offer fact-based information, but can also offer audio information, games, trivia, education, communication with social networks, customer recommendations, consumer tracking and analytics, and an interface to a museum store. The movements of the museum guest can be tracked through one or more of a variety of technologies including, but not limited to, quick response (QR) codes, radio frequency identification (RFID) tags, near-field communication (NFC) devices, Wi-Fi, indoor positioning systems (IPS), local positioning systems (LPS), cell-tracking, and global positioning systems (GPS).

The museum tour system 10 can include a host computer 12 and a server 14. The host computer 12 can be used to provide a museum portal application 18 that can be used by museum administrators to manage the museum tour system 10. The museum portal application 18 can provide a user interface in which the museum administrator can perform a number of tasks, such as adding museum object records, creating tours, editing tours, and adding museum store products that are related to certain museum objects.

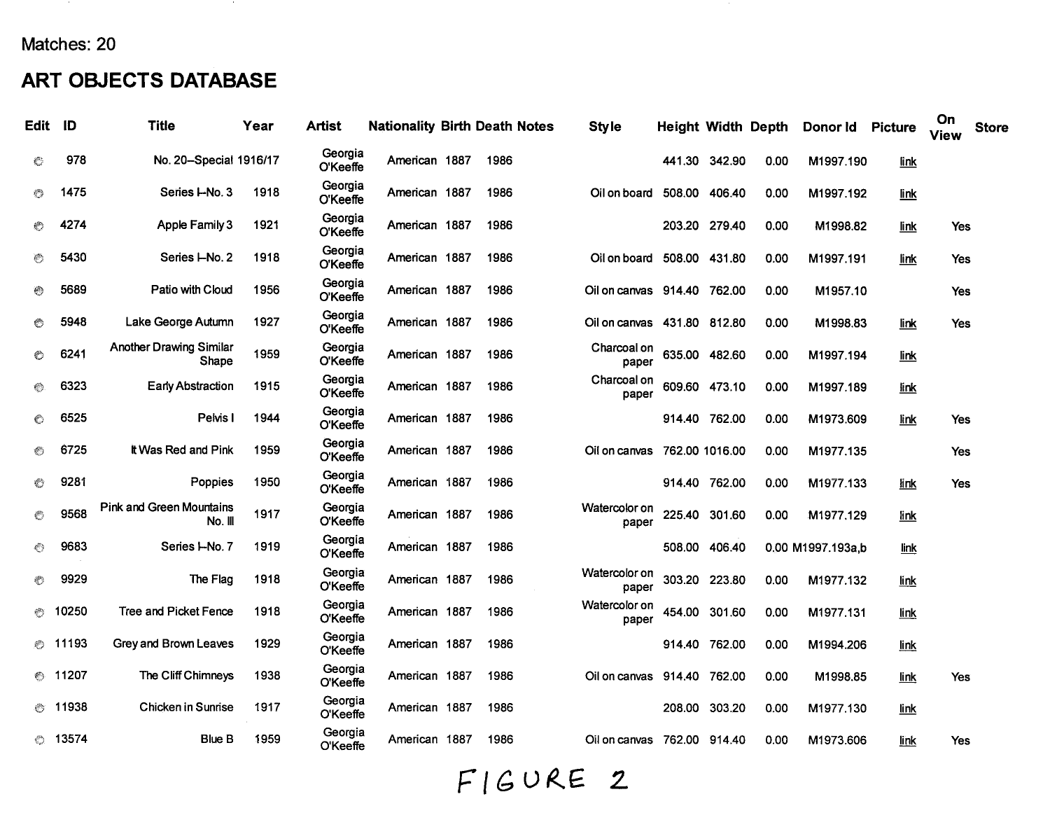

The server 14 can include a museum object database 16 in which information can be stored regarding objects in the museum, such as pieces of art or exhibits. The museum object database 16 can store a plurality of museum object records, for example, as shown in FIG. 2. In some embodiments, the museum object database 16 can be stored in the server 14 or using a cloud computing service 26. As shown in FIG. 1, the system 10 can be connected to a cloud computing service 26.

Cloud computing generally describes systems that provide computation, software, and data access services, without requiring end-user knowledge of or dependence on the system's physical location and configuration. Cloud computing describes a supplement, consumption, and delivery model for IT services based on Internet protocols, and it typically involves provisioning of dynamically scalable and often virtualized resources. This frequently takes the form of web-based tools or applications that users can access and use through a web browser as if it were a program installed locally on their own computer. According to one definition, cloud computing is a model for enabling convenient, on-demand network access to a shared pool of configurable computing resources (e.g., networks, servers, storage, applications, and services) that can be rapidly provisioned and released with minimal management effort or service provider interaction. Typical cloud computing providers deliver common business applications online that are accessed from another Web service or software like a Web browser, while the software and data are stored on servers. Most cloud computing infrastructures consist of services delivered through common centers and built on servers. Clouds often appear as single points of access for consumers' computing needs.

As shown in FIG. 1, the museum tour system 10 can also include a mobile device application 22 accessible with a mobile computing device 20. The mobile device application 22 can provide a tour segment and other information to the mobile computing device 20 when the museum guest approaches each museum object. In some embodiments, the mobile device application 22 can automatically recognizing that the museum guest is in close proximity to the museum object in order to choose the appropriate tour segment and information.

As shown in FIG. 1, the host computer 12, the server 14, and/or the mobile computing device 20 can be connected by a network 24. In one embodiment, the network 24 can include several Wi-Fi access points installed in the museum. A Wi-Fi enabled device, such as the mobile computing device 20, which can be in the form of a personal computer, smartphone, or digital audio player, can connect to the Internet when within range of a Wi-Fi access point in the museum. The coverage of one or more interconnected access points generally comprises an area the size of a few rooms, but may be expanded depending on the number of access points with overlapping coverage.

In another embodiment, the network 24 can include a local positioning system (LPS), an indoor positioning system (IPS), or a global positioning system (GPS). Global navigation satellite systems (GPS or GNSS) may not be suitable to establish indoor locations, since microwaves will be attenuated and scattered by roofs, walls and other objects. However, GNSS receivers are becoming more and more sensitive due to progress in chip technology and processing power. High-sensitivity GNSS receivers are able to receive satellite signals in most indoor environments and attempts to determine the 3D position indoors have been successful. Besides increasing the sensitivity of the receivers, the technique of A-GPS is used, where the almanac and other information are transferred though a mobile phone.

Indoor Positioning Systems (IPS) locate and track objects in buildings. These systems apply wireless concepts or optical tracking, and some systems apply ultrasound. The located objects shall be tagged with labels, tags, tokens or transponders to enable locating or positioning. There are several IPS available that make use of local reference points by either determining range measurements, angular measurements, Received Signal Strength Indicators (RSSI), or cell-id methods. Range measurements can be carried out between wireless, infrared, or ultrasound transponders.

Unlike GPS or other global navigation satellite systems, which are positioning systems with a global coverage, local positioning systems do not use technology that has global coverage; they use local technology or technology that has local coverage. Examples of this local technology include cellular base stations, Wi-Fi access points, and broadcast towers. Local positioning systems (LPS) are used as complementary (and in some cases alternative) positioning technology to GPS, especially in areas where GPS does not reach or is weak, for example, inside buildings, or between buildings in urban areas.

In order to interact with the mobile device application 22, each museum object can be identified electronically. For example, in some embodiments, each one of the museum objects can be identified by either a QR code, a RFID tag, a NFC tag, or a Bluetooth device. In the example of a QR code, the museum guest can use the mobile device application 22 to acquire and process the QR code. For example, the mobile computing device 20 can be used to scan or take a picture of the QR code, which can then be processed by the mobile device application 22. Once the QR code is obtained, the mobile device application 22 can provide an appropriate tour segment to the museum guest for the particular museum object associated with that QR code. In the examples of using a RFID tag, a NFC tag, or a Bluetooth device, no code needs to be scanned. Rather, the mobile computing device 20 is merely placed near the RFID tag, the NFC tag, or the Bluetooth device. Alternatively, the location of the mobile computing device 20 can be monitored by the Wi-Fi network, IPS, LPS, or GPS.

A QR Code is generally defined as a specific matrix barcode (or two-dimensional code), readable by dedicated QR barcode readers and camera phones. The code consists of black modules arranged in a square pattern on a white background. The information encoded can be text, URL or other data. QR is the abbreviation for Quick Response, as the creator intended the code to allow its contents to be decoded at high speed. QR codes are now used in a much broader context, including both commercial tracking applications and convenience-oriented applications aimed at mobile phone users (known as mobile tagging).

QR codes storing addresses and URLs may appear in magazines, on signs, buses, business cards, or on just about any object about which users might need information. Users with a camera phone equipped with the correct reader application can scan the image of the QR Code to display text, contact information, connect to a wireless network, or open a web page in the phone's browser. This act of linking from physical world objects is known as a hardlink or physical world hyperlinks.

Micro QR code is a smaller version of the QR code standard for applications with less ability to handle large scans. There are different forms of Micro QR codes as well. The highest of these can hold 35 numeric characters.

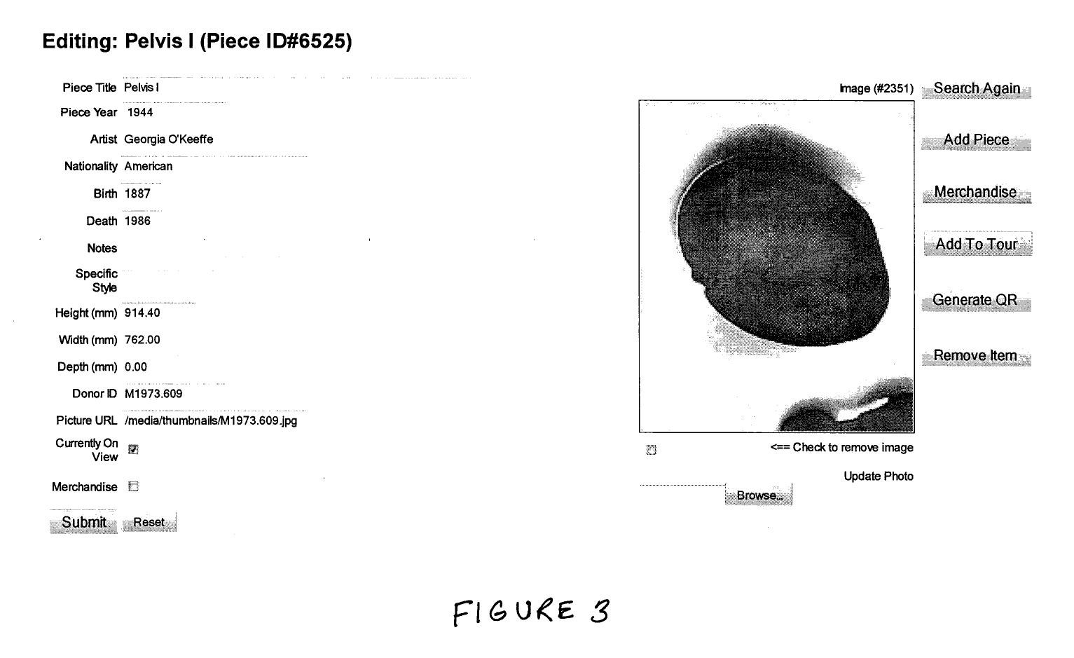

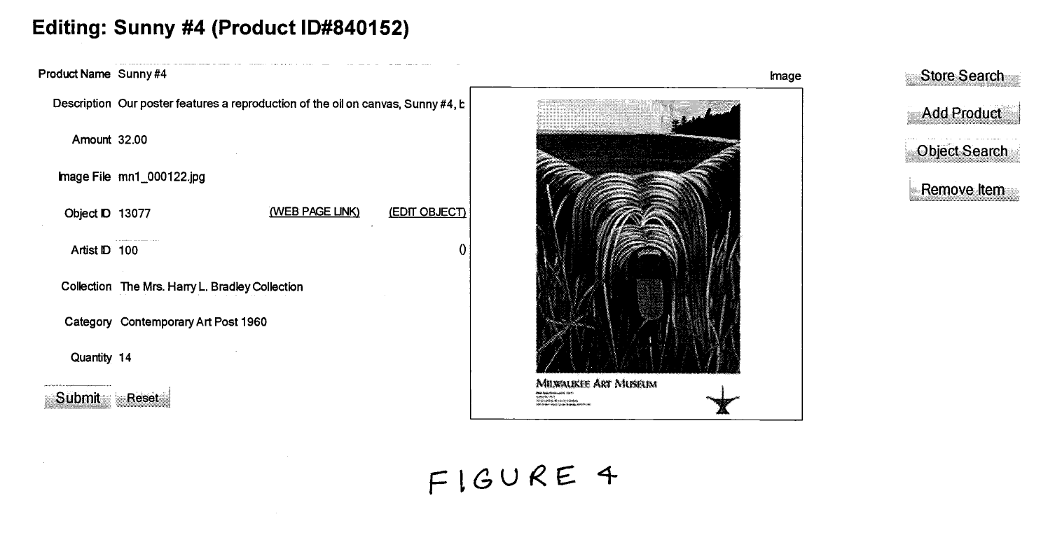

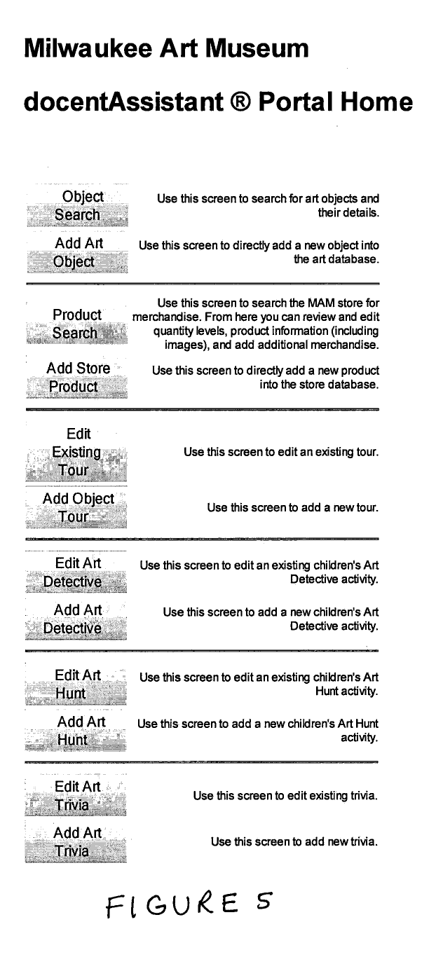

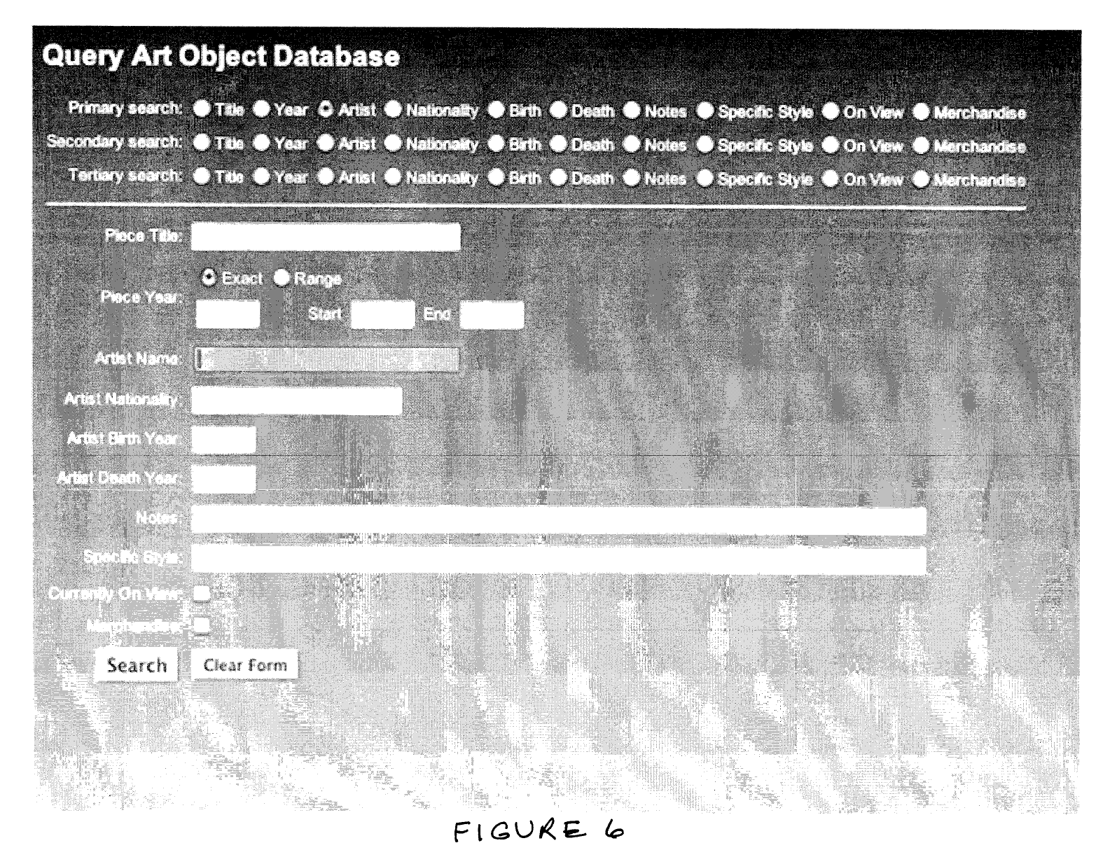

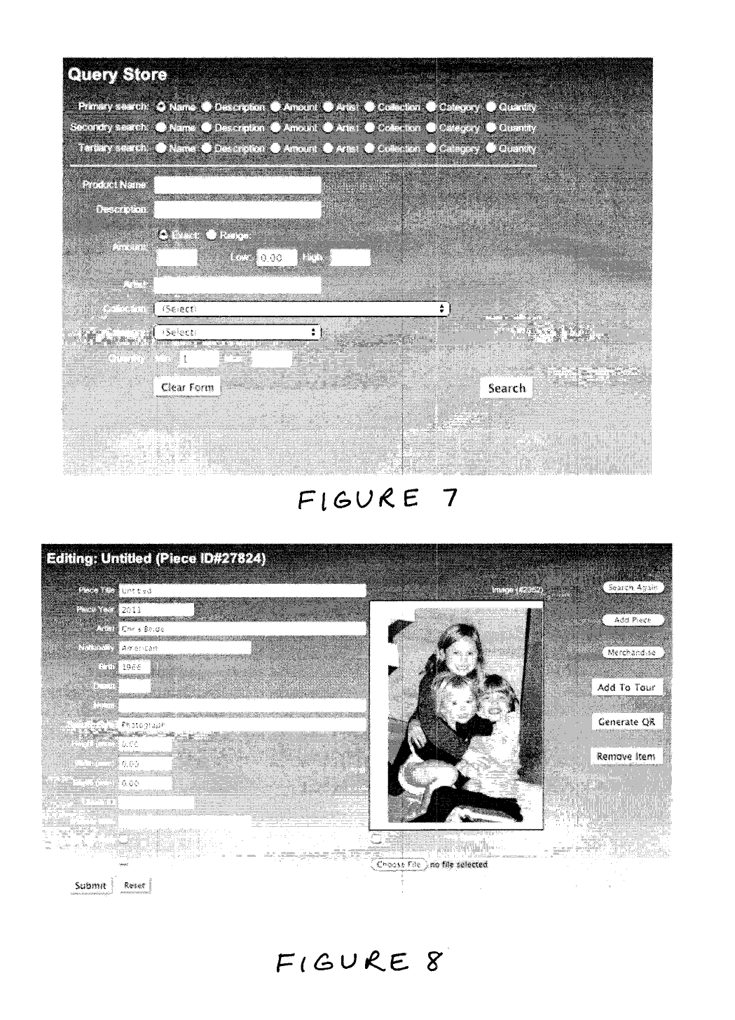

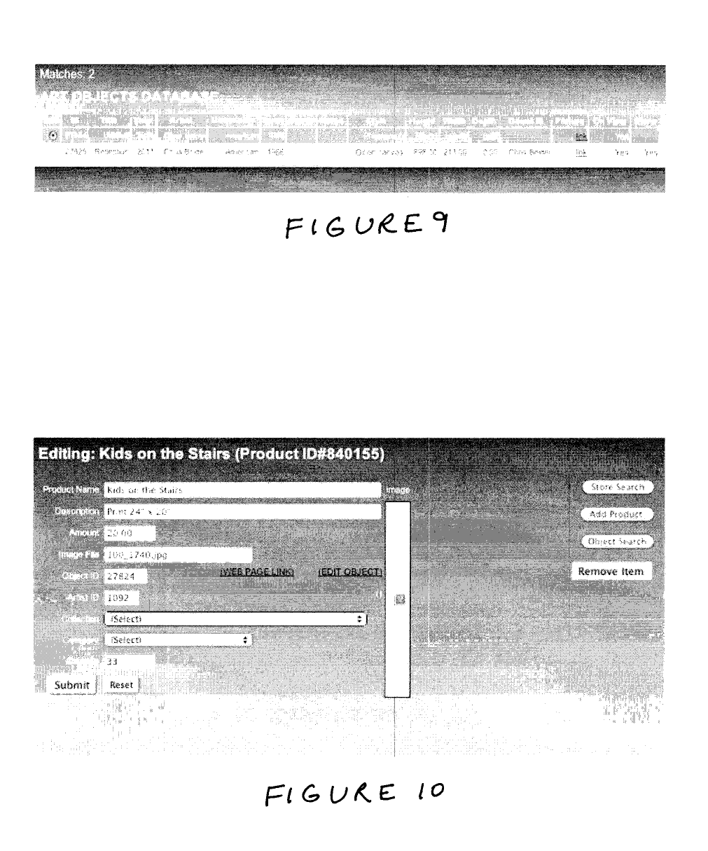

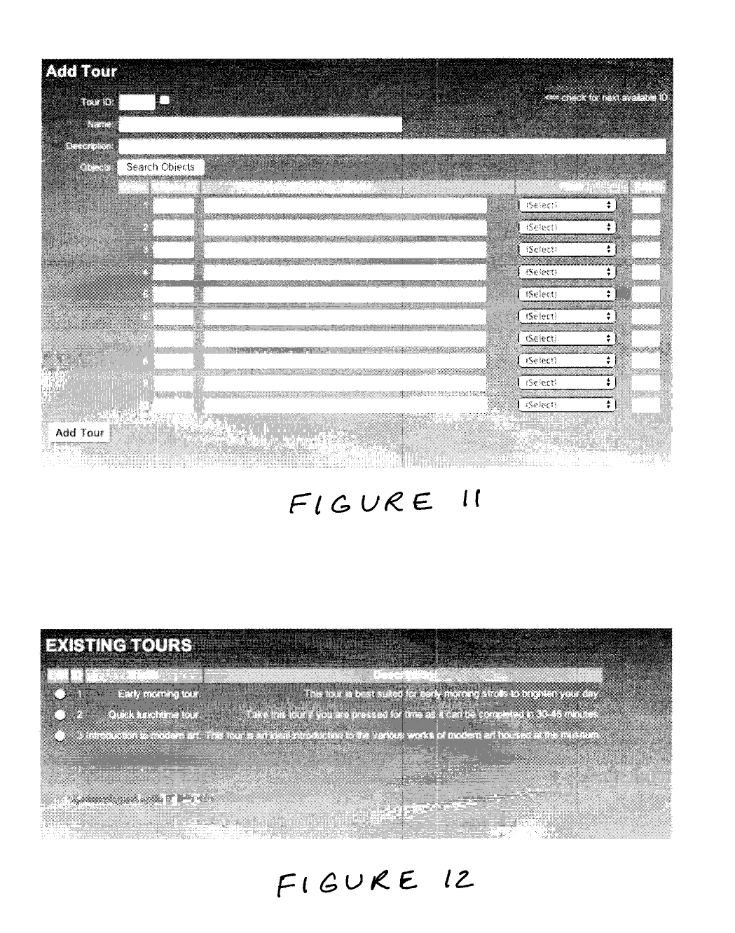

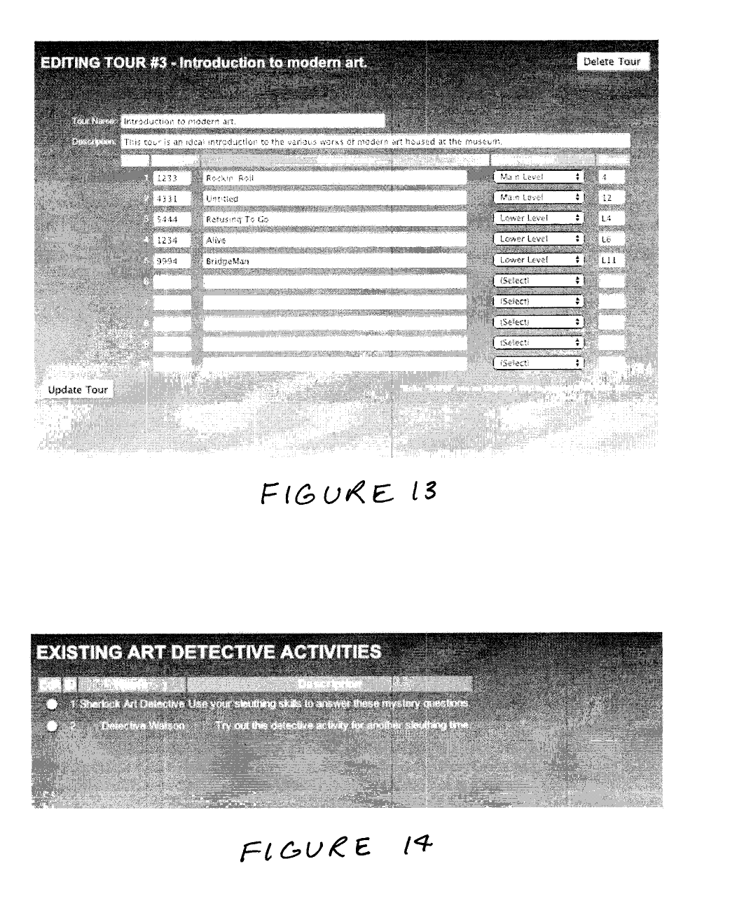

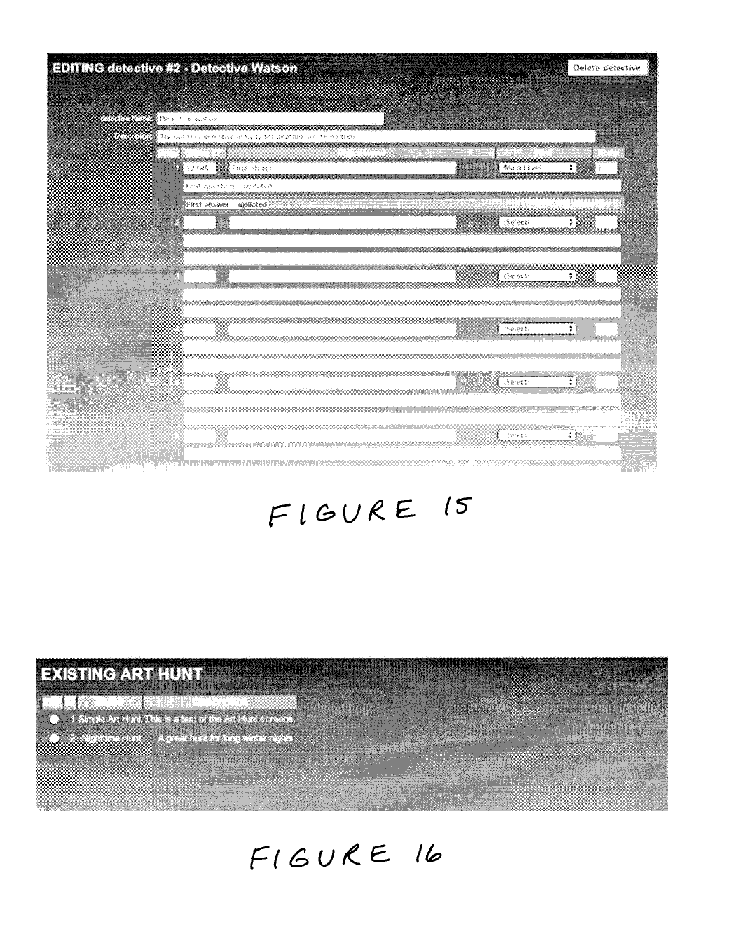

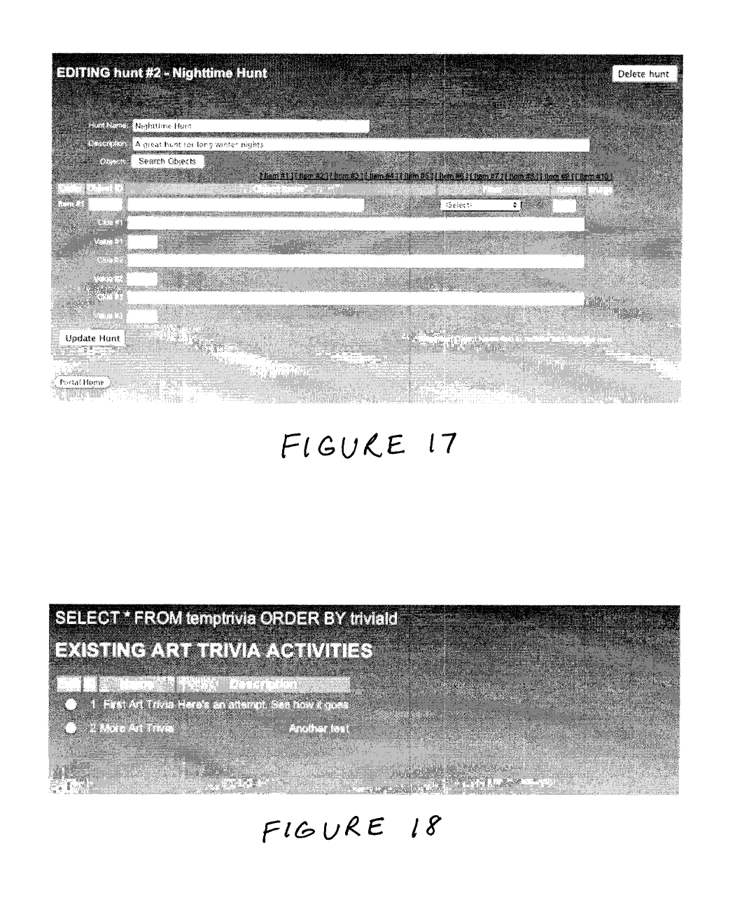

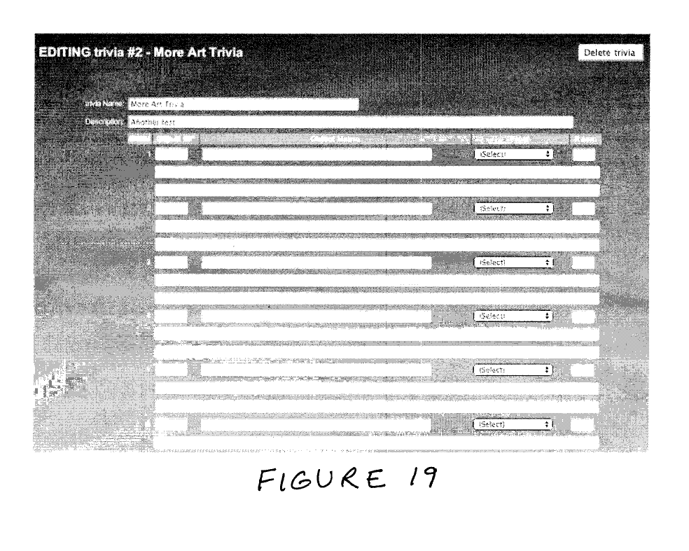

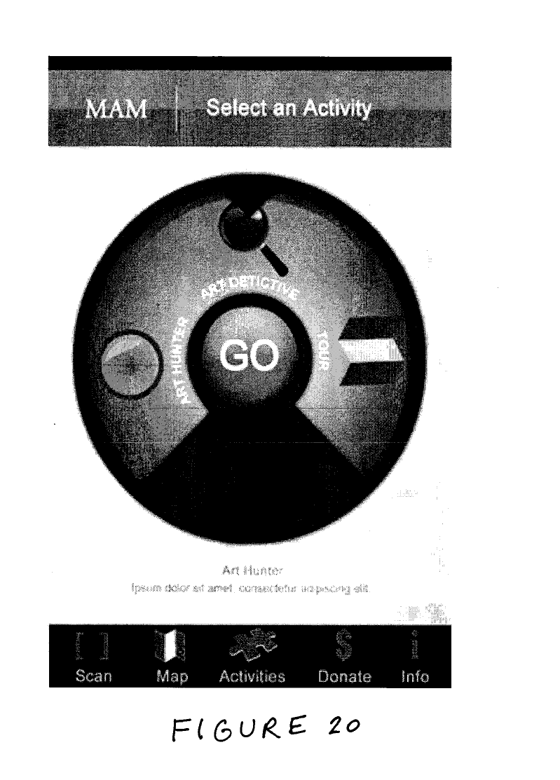

FIGS. 2-19 illustrate screens of the museum portal according to one embodiment of the invention. FIG. 2 illustrates a plurality of museum object records. FIG. 3 illustrates a single museum object record. FIG. 4 illustrates a museum product record. FIG. 5 illustrates a museum portal home. FIG. 6 illustrates a museum object search page. FIG. 7 illustrates a product search page. FIG. 8 illustrates an edit object page. FIG. 9 illustrates an object search results page. FIG. 10 illustrates an edit product page. FIG. 11 illustrates an add tour page. FIG. 12 illustrates a tour search results page. FIG. 13 illustrates an edit tour page. FIGS. 14, 16, and 18 illustrate existing activity search results pages. FIGS. 15, 17, and 19 illustrate edit existing activity pages.

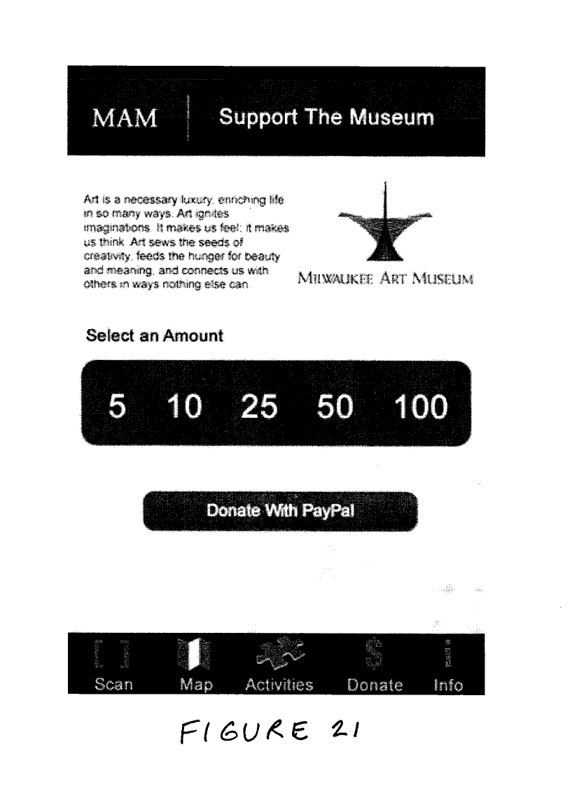

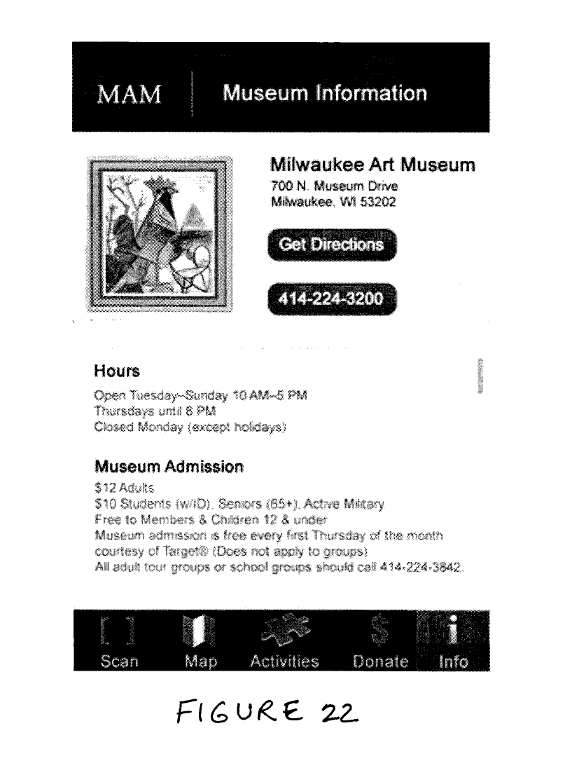

FIGS. 20-31 illustrate graphical screens for use in the mobile device application 22. FIG. 20 illustrates a select an activity screen. FIG. 21 illustrates a donation screen. FIG. 22 illustrates a museum general information screen.

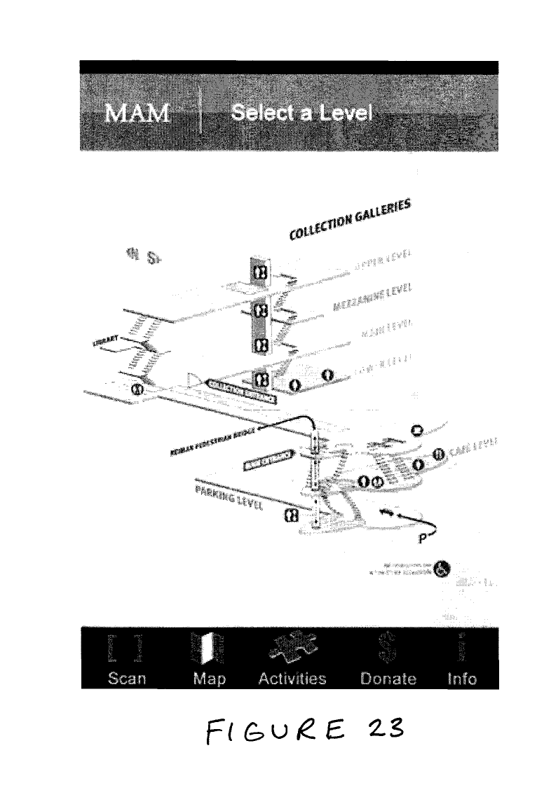

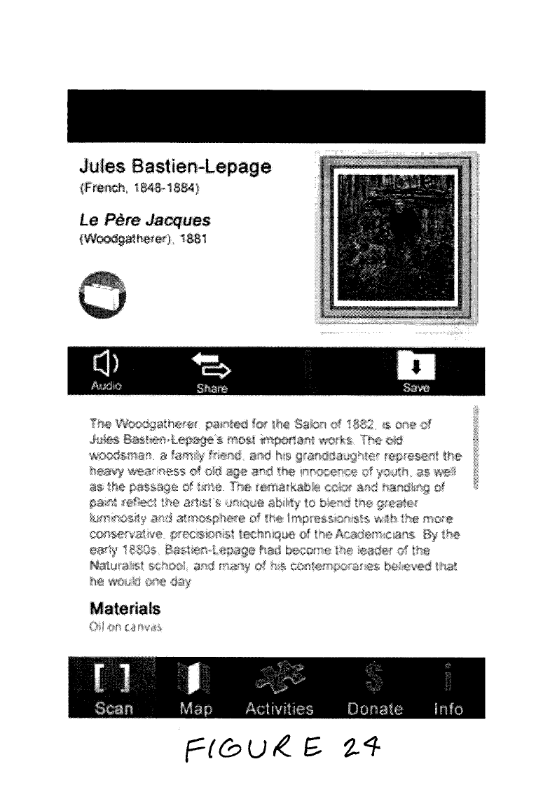

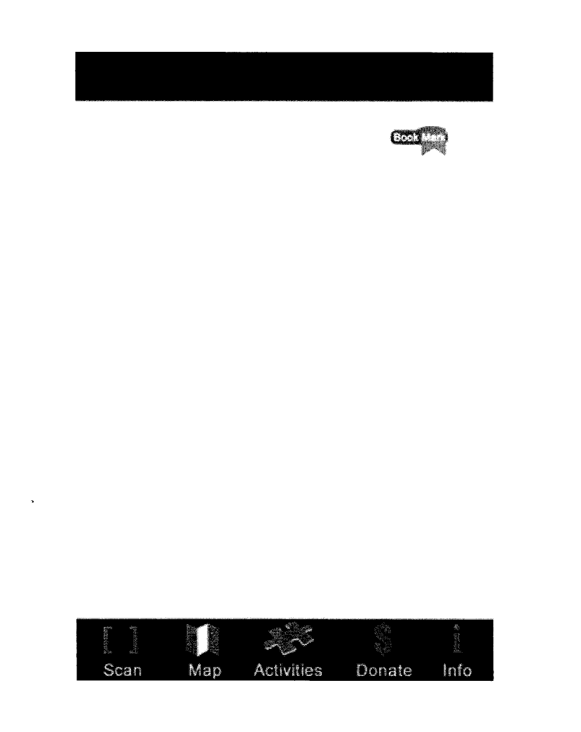

FIG. 23 illustrates a museum map screen. If a museum guest taps the screen on a portion of the museum map, a particular room within the museum can be shown to the museum guest. In this manner, the museum guest can use the museum map to navigate through each room of the museum.

FIG. 24 illustrates a museum object tour page. In some embodiments, the museum object tour page can automatically be displayed on the mobile computing device 20 as the museum guest approaches the museum object. Alternatively, the museum guest can take a picture of a QR code affixed near the museum object, and the mobile device application 22 can locate the appropriate audio tour using the QR code as an identifier of the museum object. The museum guest's mobile computing device 20 can recognize the museum object via the network 24, the QR code, or other codes, and can query the database 16 and return details about the museum object being viewed. The museum guest can then be offered many options through the mobile device application 22, including receiving audio information, posting on a social network, getting recommendations, taking tours, and playing related games and trivia.

The museum object tour page can include an audio button that can be tapped by the museum guest when he or she is ready to hear an audio tour of that particular museum object. In some embodiments, text-to-voice technology can be used to generate the audio tour. For example, a text-to-speech (TTS) system can be used to convert normal language text into speech. Synthesized speech can be created by concatenating pieces of recorded speech that are stored in the database 16. Systems differ in the size of the stored speech units; a system that stores phones or diphones provides the largest output range. For specific usage domains, the storage of entire words or sentences allows for high-quality output. Alternatively, a synthesizer can incorporate a model of the vocal tract and other human voice characteristics to create a completely “synthetic” voice output.

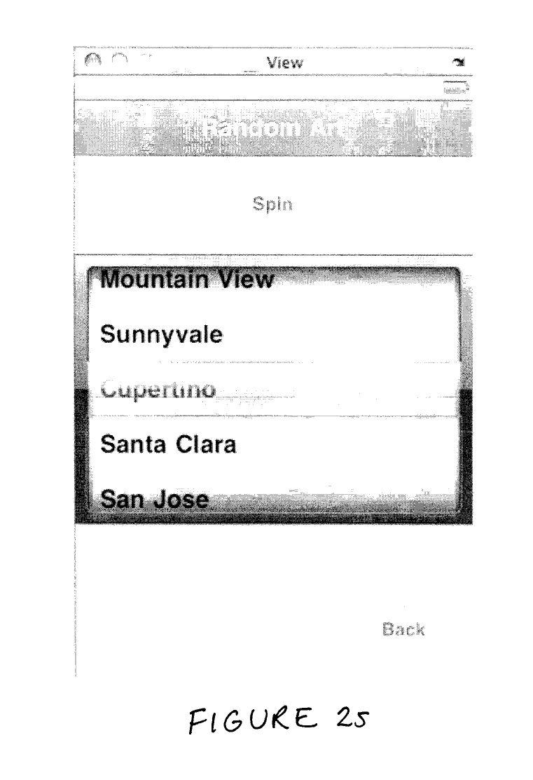

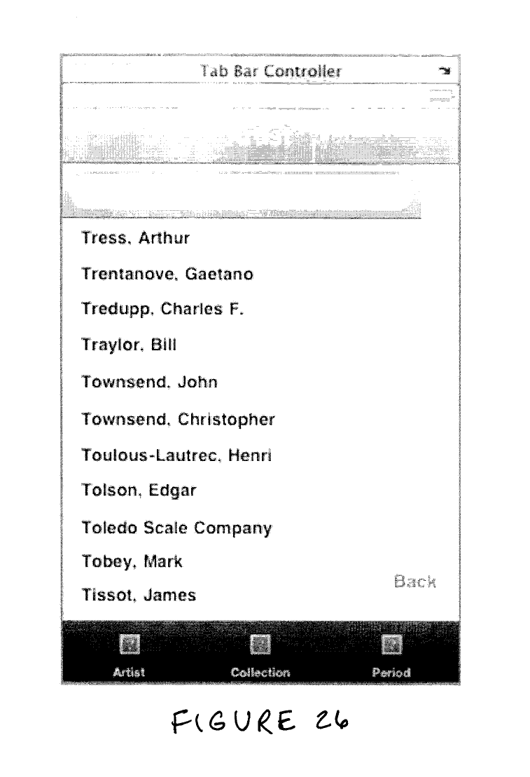

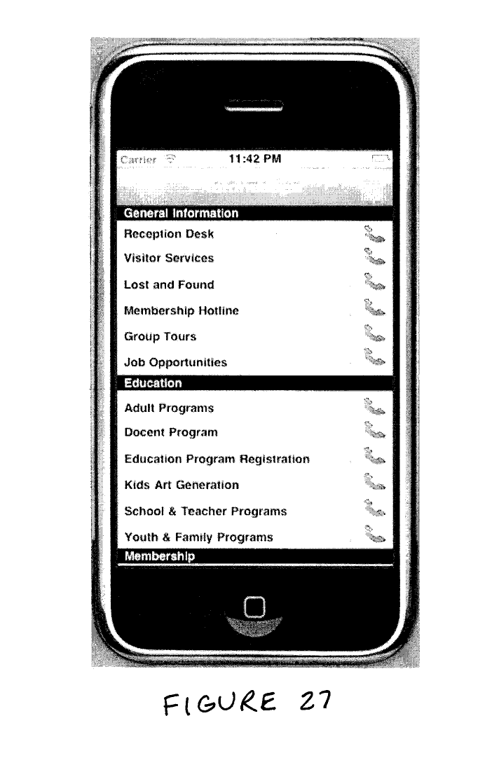

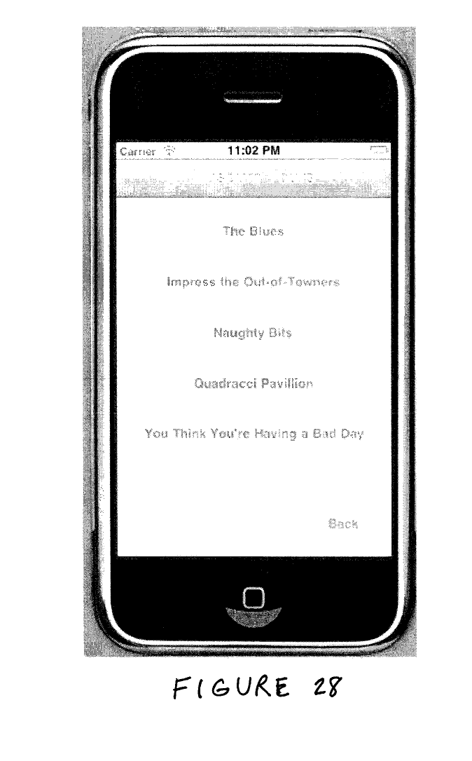

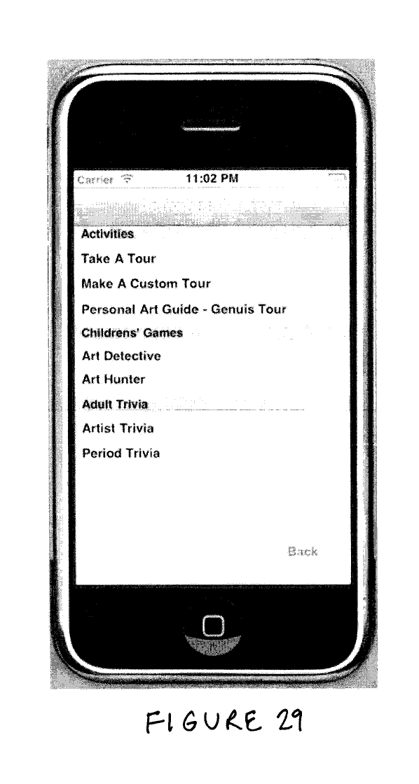

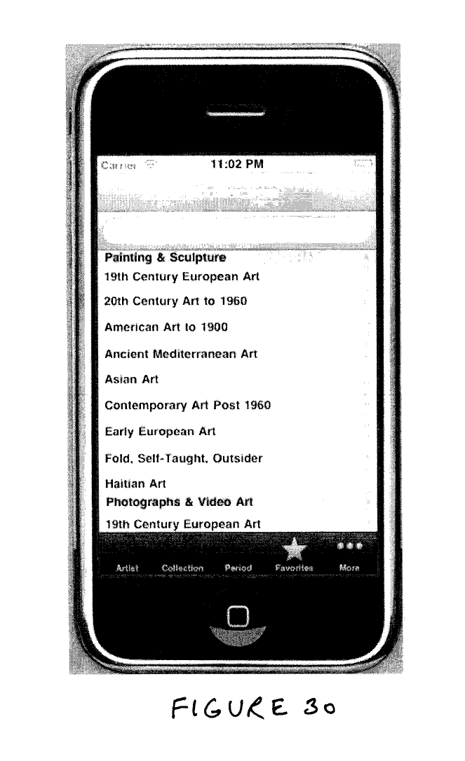

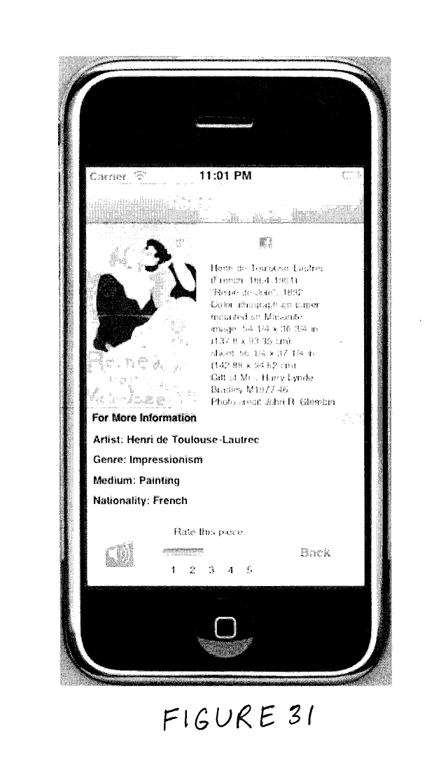

FIG. 25 illustrates a museum location search screen. FIG. 26 illustrates an artist search screen. FIG. 27 illustrates another museum general information screen. FIG. 28 illustrates a museum tour selection screen. FIG. 29 illustrates an activities and trivia selection screen. FIG. 30 illustrates a museum collection search screen. FIG. 31 illustrates another museum object tour screen.

Although the invention is described herein with respect to museums, some embodiments of the invention can be used in zoos, amusement parks, theme parks, large retail stores, shopping centers, outdoor festivals, trade shows, auction houses, etc. For example, as guests tour a zoo or theme park, the mobile device application 22 can provide audio tours and information about each zoo exhibit or park attraction. The network 24 can include a Wi-Fi network, a IPS, a LPS, or GPS and the guest's mobile computing device 20 can be recognized as approaching a zoo exhibit or park attraction as the guest moves through the zoo or park.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A museum tour system implemented with a host computer, a server, and a mobile computing device connected by a network, the museum tour system used by a museum administrator and a museum guest, the museum guest viewing museum objects, the system comprising:
a museum object database in the server, the museum object database storing a plurality of museum object records;
a museum portal accessible on the host computer, the museum portal providing a user interface in which the museum administrator at least one of adds museum object records, creates tours, edits tours, and adds products; and
a mobile device application accessible with the mobile computing device, the mobile device application providing a tour segment to the mobile computing device of the museum guest when the museum guest approaches the museum object, the mobile device application recognizing a proximity of the museum guest to the museum object in order to choose the appropriate tour segment.

2. The system of claim 1 wherein the network includes a plurality of Wi-Fi access points installed in the museum.

3. The system of claim 1 wherein the network includes one of a local positioning system, an indoor positioning system, and a global positioning system.

4. The system of claim 1 wherein the mobile computing device is owned by the museum guest.

5. The system of claim 1 wherein each one of the plurality of museum object records includes at least one of an identification number, a title, a collection, a creation year, an artist, a nationality, a birth year, a death year, a style, a dimension, a donor identification, a photograph, a digital reproduction, a viewing status, and an associated product.

6. The system of claim 5 wherein product information regarding the associated product is stored in the database, the product information including at least one of a price and an available quantity.

7. The system of claim 1 wherein the user interface of the museum portal includes at least one of a portal home page, an object search page, an add object page, a product search page, an edit existing tour page, and an add object tour page.

8. The system of claim 1 wherein the museum is an art museum and the museum portal includes at least one of an edit art detective tour page, an add art detective object page, an edit art hunt tour page, an add art hunt object page, an edit art trivia tour page, and an add art trivia object page.

9. The system of claim 1 wherein the mobile device application accesses a select an activity screen including a graphical user interface to select one of a museum tour and a museum activity.

10. The system of claim 1 wherein the mobile device application accesses a donation screen for use by the museum guest to donate money to the museum.

11. The system of claim 1 wherein the mobile device application accesses a museum general information page including at least one of a museum address, directions to the museum, a museum phone number, museum hours of operation, and museum admission prices.

12. The system of claim 1 wherein the mobile device application accesses a museum map screen.

13. The system of claim 1 wherein the mobile device application accesses a museum object tour page for each one of the plurality of museum object records.

14. The system of claim 13 wherein the museum object tour page includes at least one of an a museum object title, an artist name, an artist lifespan, an object creation date, an information summary, a product icon, an audio tour icon, a social networking icon, a more information icon, a save icon, a rating icon, and a recommendation icon.

15. The system of claim 1 wherein each one of the museum objects is identified by at least one of a QR code and a RFID tag.

16. The system of claim 15 wherein the museum guest uses the mobile device application to acquire and process the at least one of the QR code and the RFID tag.

17. The system of claim 16 wherein the mobile device application provides an appropriate tour segment based on the at least one of the QR code and the RFID tag.
